(19) United States
(12) Patent Application Publication
(10) Pub. No.: US 2026/0212790 A1
(43) Pub. Date: Jul. 23, 2026

(54) METHOD FOR CONTROLLING DISPLAY DEVICE, INSPECTION DEVICE, AND ELECTRONIC DEVICE

(71) Applicant: Samsung Display Co., LTD., Yongin-si (KR)

(72) Inventor: Kee Yong KIM, Yongin-si (KR)

(21) Appl. No.: 19/384,019

(22) Filed: Nov. 10, 2025

(30) Foreign Application Priority Data
Jan. 23, 2025 (KR) 10-2025-0010683

(51) Int. Cl. G09G 3/00

(52) U.S. Cl. CPC G09G 3/006; G09G 2320/0233; G09G 2320/0271; G09G 2330/12

(57) ABSTRACT

A method of controlling a display device includes: providing reference image data having a reference grayscale to the display device, to obtain a first image displayed by a display panel of the display device; calculating a first index for image quality of the display panel from the first image; providing compensation image data, to which a compensation grayscale is applied to the reference grayscale, to the display device to obtain a second image displayed on the display panel; calculating a second index for image quality of the display panel from the second image; and controlling the display device to apply the compensation grayscale when the second index is greater than the first index.

This application claims priority to Korean Patent Application No. 10-2025-0010683, filed on January 23, 2025, and all the benefits accruing therefrom under 35 U.S.C. §119, the content of which in its entirety is herein incorporated by reference.

### BACKGROUND

### 1. Field

The present disclosure relates to a method for controlling a display device, an inspection device, and an electronic device.

### 2. Description of the Related Art

With the development of information technology, the importance of a display device, which is a connection medium between a user and information, is being highlighted. Accordingly, the use of display devices such as liquid crystal display devices and organic light emitting display devices is increasing.

### SUMMARY

Even if display devices are formed in a same process, the display devices may have different luminances or stains due to process variation or the like. These stains may be removed, compensation data may be generated to improve luminance uniformity, and compensation data may be applied to the display device. However, when the compensation data is collectively applied the display devices, a compensation deviation may occur depending on the display devices. Accordingly, the quality degradation of the display device may occur even after compensation is performed.

Embodiments of the present disclosure are to provide a method of controlling a display device having improved display quality, an inspection device, and an electronic device. For example, the method of controlling the display device may improve the display quality of the display device by selectively applying compensation by comparing before and after compensation.

A method for controlling a display device according to an embodiment of the present disclosure includes: providing reference image data having a reference grayscale to the display device to obtain a first image displayed by a display panel of the display device; calculating a first index for image quality of the display panel from the first image; providing compensation image data, to which a compensation grayscale is applied to the reference grayscale, to the display device to obtain a second image displayed on the display panel; calculating a second index for image quality of the display panel from the second image; and controlling the display device to apply the compensation grayscale when the second index is greater than the first index.

In an embodiment, the method may further include controlling the display device not to apply the compensation grayscale when the second index is less than or equal to the first index.

In an embodiment, the method may further include determining a defect of the display device based on one of the first index and the second index.

In an embodiment, the determining the defect of the display device may include: determining that the display device is defective when the compensation grayscale is applied to the display device and the second index is less than a predetermined target index.

In an embodiment, the determining the defect of the display device may include: determining that the display device is defective when the compensation grayscale is not applied to the display device and the first index is less than a predetermined target index.

In an embodiment, the first index may be calculated based on the reference grayscale and a grayscale of the first image displayed on the display panel with the reference image data, and the second index may be calculated based on the reference grayscale and a grayscale of the second image displayed on the display panel with the compensation image data.

A method for controlling a display device according to another embodiment of the present disclosure includes: providing reference image data having a reference grayscale to a first display device to obtain a reference image displayed on a display panel of the first display device; obtaining a first pattern based on the grayscale of the reference image; providing the reference image data to a second display device to obtain a first image displayed on a display panel of the second display device; obtaining a second pattern based on the grayscale of the first image; and controlling the second display device to apply a compensation grayscale that compensates for the reference grayscale of the first display device, when the first pattern and the second pattern match each other.

In an embodiment, the method may further include controlling the second display device not to apply a compensation grayscale that compensates for the reference grayscale of the first display device, when the first pattern and the second pattern do not match each other.

In an embodiment, the method may further include when the compensation grayscale is not applied to the second display device, calculating a first index for image quality of a display panel of the second display device from the first image; and determining a defect of the second display device based on the first index.

In an embodiment, the determining a defect of the second display device may include: determining that the second display device is defective when the first index is less than a predetermined target index.

In an embodiment, the method may further include when the compensation grayscale is applied to the second display device, providing compensation image data to which the compensation grayscale is applied to the second display device to obtain a second image displayed on the display panel of the second display device; and calculating a second index for image quality of the display panel from the second image.

In an embodiment, the method may further include determining a defect of the second display device based on the second index.

In an embodiment, the determining the defect of the second display device may include: determining that the second display device is defective when the second index is less than a predetermined target index.

An inspection device for inspecting a display device according to an embodiment of the present disclosure includes: a controller; and a camera which obtains, in response to control of the controller, a first image displayed on a display panel of the display device based on reference image data having a reference grayscale, and a second image displayed on the display panel based on compensation image data, to which a compensation grayscale is applied to compensate for the reference grayscale, where the controller calculates a first index for image quality of the display panel from the first image, and a second index for image quality from the second image, controls the display device to apply the compensation grayscale when the second index is greater than the first index, and determines a defect of the display device based on one of the first index and the second index.

In an embodiment, the controller may control the display device not to apply the compensation grayscale when the second index is less than or equal to the first index.

In an embodiment, the controller may determine that the display device is defective when the compensation grayscale is not applied to the display device and the first index is less than a predetermined target index.

In an embodiment, the controller may determine that the display device is defective when the compensation grayscale is applied to the display device and the second index is less than a predetermined target index.

An electronic device according to an embodiment of the present disclosure includes: a processor; and a display device including pixels, where the display device displays an image on the pixels under a control of the processor, and the electronic device is controlled according to the method described above.

### BRIEF DESCRIPTION OF THE DRAWINGS

FIG. 1 is a diagram illustrating a display device and an inspection device according to an embodiment of the present disclosure.

FIG. 2 is a block diagram illustrating an embodiment of the display device of FIG. 1.

FIG. 3 is a block diagram illustrating an embodiment of one of the sub-pixels of FIG. 2.

FIG. 4 is a block diagram illustrating an embodiment of the inspection device of FIG. 1.

FIG. 5 is a flowchart illustrating a method of controlling a display device according to an embodiment of the present disclosure.

FIG. 6 is a diagram illustrating an embodiment of compensation grayscale applied to the display device of FIG. 5.

FIG. 7 is a diagram illustrating an embodiment in which a compensation grayscale is applied to the display device of FIG. 5.

FIG. 8 is a diagram illustrating an embodiment in which a compensation grayscale is not applied to the display device of FIG. 5.

FIG. 9 is a flowchart illustrating a method of controlling a display device according to another embodiment of the present disclosure.

FIG. 10 is a diagram illustrating an embodiment in which the first pattern and the second pattern of FIG. 9 are matched.

FIG. 11 is a block diagram illustrating an embodiment of an electronic device including the display device of FIG. 2.

FIG. 12 is a diagram illustrating an example where the electronic device of FIG. 11 is a smartphone.

FIG. 13 is a diagram illustrating an example where the electronic device of FIG. 11 is a tablet computer.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

Throughout the specification, in a case where a portion is "connected" to another portion, the case includes not only a case where the portion is "directly connected" but also a case where the portion is "indirectly connected" with another element interposed therebetween.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. "At least one of X, Y, and Z" and "at least any one selected from X, Y, and Z" may be interpreted as one X, one Y, one Z, or any combination of two or more of X, Y, and Z (for example, XYZ, XYY, YZ, and ZZ). It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

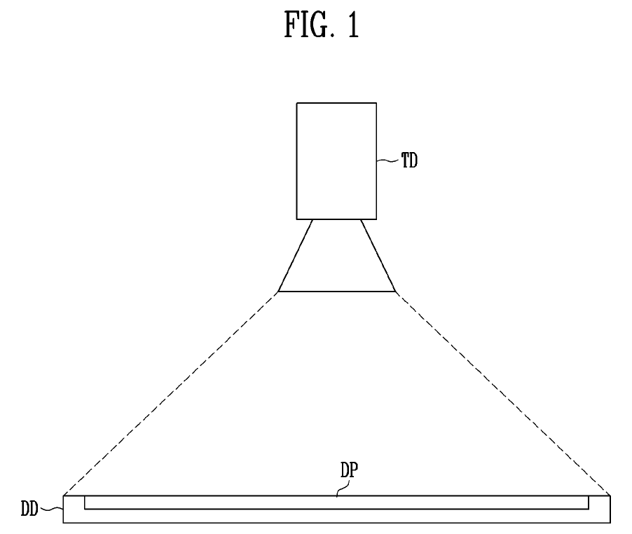

FIG. 1 is a diagram illustrating a display device and an inspection device according to an embodiment of the present disclosure.

Referring to FIG. 1, an embodiment of a display device DD may include a display panel DP including a plurality of pixels. Each of the pixels may emit light, and the display device DD may display an image on the display panel DP through light emitted from the pixels.

An embodiment of the inspection device TD may capture an image displayed on the display panel DP of the display device DD through a camera. The inspection device TD may capture an image displayed on the display panel DP in response to the image data provided to the display device DD. The inspection device TD may obtain an image including a plurality of grayscales. Here, a plurality of grayscales may include 0 to 255 grayscales. However, embodiments are not limited thereto.

According to an embodiment, when the display device DD displays an image by receiving reference image data having a reference grayscale, the inspection device TD may capture the image and obtain an image before compensation for the display device DD. When the display device DD receives the compensation image data, to which the compensation grayscale is applied to the reference grayscale, and displays an image, the inspection device TD may capture the image and obtain a pre-compensation image for the display device DD.

The inspection device TD may selectively determine whether to apply a compensation grayscale to the display device DD before shipment of the product. According to an embodiment, the inspection device TD may calculate an index for the image quality of the display panel DP by measuring a grayscale from the acquired image. The inspection device TD may determine whether to apply the compensation grayscale according to the calculated index for the image quality of the display panel DP. The display device DD may selectively apply the compensation grayscale according to the determination of the inspection device TD. In an embodiment, for example, when the index in the compensated image for the display device DD is greater than the index in the pre-compensation image, the display device DD may control to apply the compensation grayscale. Here, the index is calculated based on the grayscale, and the index may become greater as the image quality of the display panel DP improves.

The inspection device TD may inspect whether the display device DD is defective before the product is shipped. The inspection device TD may compare the index of the image quality of the display device DD with a predetermined target index to determine whether the display device DD is defective. In an embodiment, for example, when the index calculated based on the grayscale of the display device DD exceeds a predetermined target index, the inspection device TD may determine that the index is normal, and when the index does not exceed the predetermined target index, it may determine that the display device DD is defective.

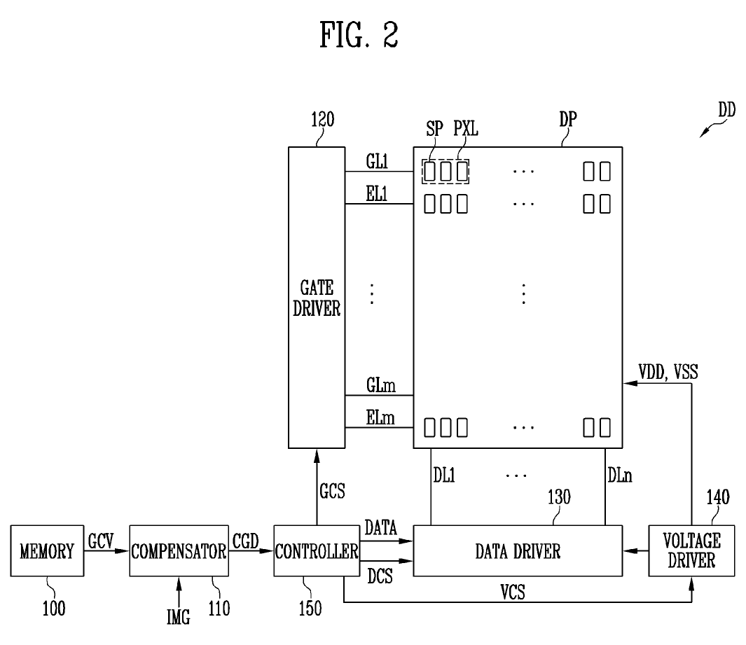

FIG. 2 is a block diagram illustrating an embodiment of the display device of FIG. 1.

Referring to FIG. 2, an embodiment of a display device DD may include a display panel DP, a memory 100, a compensator 110, a gate driver 120, a data driver 130, a voltage generator 140, and a controller 150.

The display panel DP may include sub-pixels SP. The sub-pixels SP may be connected to the gate driver 120 through the first to m-th gate lines GL1 to GLm. The sub-pixels SP may be connected to the data driver 130 through the first to n-th data lines DL1 to DLn.

Each of the sub-pixels SP may include at least one light emitting element configured to generate light. Accordingly, each of the sub-pixels SP may generate light of a specific color, such as red, green, blue, cyan, magenta, yellow, or the like. Two or more sub-pixels of the sub-pixels SP may constitute one pixel PXL. In an embodiment, for example, as shown in FIG. 2, three sub-pixels may constitute one pixel PXL.

The gate driver 120 may be connected to the sub-pixels SP arranged in the row direction through the first to m-th gate lines GL1 to GLm. The gate driver 120 may output gate signals to the first to m-th gate lines GL1 to GLm in response to the gate control signal GCS. In embodiments, the gate control signal GCS may include a start signal indicating the start of each frame, a horizontal synchronization signal for outputting gate signals in synchronization with the timing at which the data signals are applied, and the like.

In embodiments, the first to m-th emission control lines EL1 to ELm connected to the sub-pixels SP in the row direction may be further provided. In such embodiments, the gate driver 120 may include a light emission control driver configured to control the first to m-th light emission control lines EL1 to ELm, and the light emission control driver may operate according to the control of the controller 150.

The gate driver 120 may be disposed on one side of the display panel DP. However, embodiments are not limited thereto. In an embodiment, for example, the gate driver 120 may be divided into two or more drivers that are physically and/or logically divided, and such drivers may be disposed on one side of the display panel DP and the other side of the display Panel DP opposite to the one side. As such, the gate driver 120 may be disposed around the display panel DP in various forms according to embodiments.

The data driver 130 may be connected to the sub-pixels SP arranged in the column direction through the first to n-th data lines DL1 to DLn. The data driver 130 may receive the image data DATA and the data control signal DCS from the controller 150. The data driver 130 may operate in response to the data control signal DCS. In embodiments, the data control signal DCS may include a source start pulse, a source shift clock, a source output enable signal, and the like.

The data driver 130 may use the voltages from the voltage generator 140 to apply data signals having grayscale voltages corresponding to the image data DATA to the first to n-th data lines DL1 to DLn. When a gate signal is applied to each of the first to m-th gate lines GL1 to GLm, data signals corresponding to the image data DATA may be applied to the data lines DL1 to DLm. Accordingly, the corresponding sub-pixels SP may generate light corresponding to the data signals, such that an image may be displayed on the display panel DP.

In embodiments, gate driver 120 and data driver 130 may include complementary metal-oxide semiconductor (CMOS) circuit elements.

The voltage generator 140 may operate in response to a voltage control signal VCS from the controller 150. The voltage generator 140 may be configured to generate a plurality of voltages and provide the generated voltages to components of the display device DD. In an embodiment, for example, the voltage generator 140 may be configured to receive an input voltage from outside the display device DD, adjust the received voltage, and regulate the adjusted voltage, thereby generating a plurality of voltages.

The voltage generator 140 may generate a first power supply voltage VDD and a second power supply voltage VSS, and the generated first and second power supply voltages VDD and VSS may be provided to the sub-pixels SP. The first power supply voltage VDD may have a relatively high voltage level, and the second power supply voltage VSS may have a lower voltage level than the first power supply voltage VDD. In other embodiments, the first power supply voltage VDD or the second power supply voltage VSS may be provided by an external device of the display device DD.

In addition, the voltage generator 140 may generate various voltages. In an embodiment, for example, the voltage generator 140 may generate an initialization voltage applied to the sub-pixels SP. In an embodiment, for example, during the sensing operation to sense the electrical characteristics of the transistors and/or light emitting elements of the sub-pixels SP, a predetermined reference voltage may be applied to the first to n-th data lines DL1 to DLn, and the voltage generator 140 may generate the reference voltage.

The memory 100 may store a compensation grayscale GCV for compensating the grayscale to improve the image quality of the display panel DP. Whether or not the compensation grayscale GCV is applied may be determined by the inspection device TD of FIG. 1. In an embodiment, for example, a compensation grayscale GCV may be generated for each of the sub-pixels SP and stored on the memory 100. In an embodiment, for example, the compensation grayscale GCV may be generated for each block unit including a predetermined number of sub-pixels SP and stored in the memory 100.

The memory 100 may be independently configured in the display device DD. However, embodiments are not limited thereto. In an embodiment, for example, the memory 100 may be implemented in an embedded form within the controller 150.

The compensator 110 may receive input image data IMG from the outside (e.g., a graphics processor) and receive a compensation grayscale GCV stored in the memory 100. The compensator 110 may generate the compensation image data CGD obtained by correcting the input image data IMG based on the compensation grayscale GCV, and provide the compensation image data to the controller 150. In an embodiment, as shown in FIG. 2, the compensator 110 may be configured separately from the controller 150. However, embodiments are not limited thereto. In another embodiment, for example, the compensator 110 and the controller 150 may be integrated as a single unit. In another embodiment, for example, the compensator 110 may be implemented in an embedded form within the controller 150.

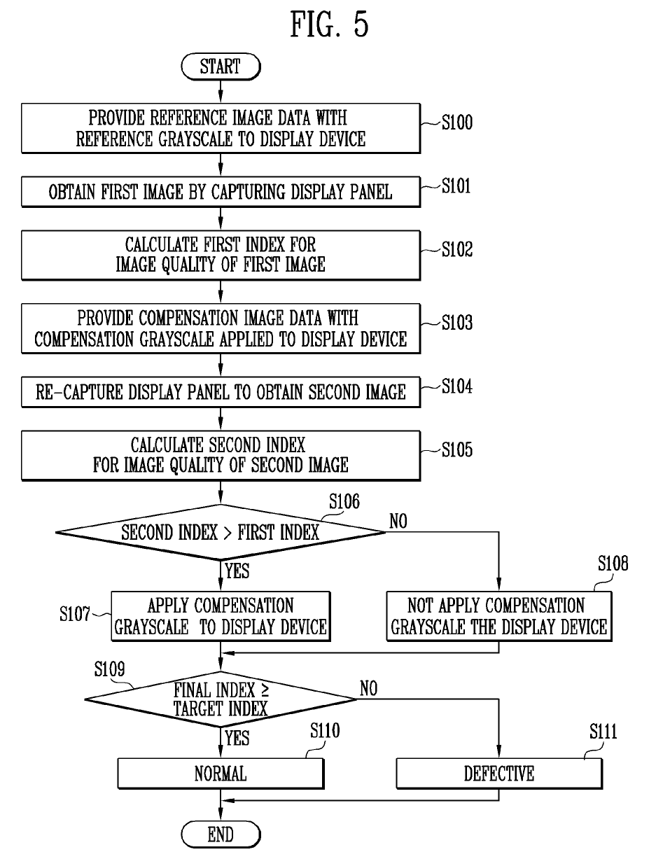

According to the compensation image data CGD generated by applying the compensation grayscale GCV, grayscales of the sub-pixels SP included in the display panel DP are corrected, so that image quality on the display panel DP may be improved. However, even if the compensation grayscale GCV is applied according to the display device DD, the grayscale of the sub-pixels SP may not be corrected, and as a result, the image quality on the display panel DP may be degraded. Accordingly, the display quality may be improved by selectively applying the compensation grayscale GCV according to the display device DD. An embodiment of a method for controlling the display device DD will be described later in greater detail with reference to FIGS. 5 to 10.

The controller 150 may control various operations of the display device DD. The controller 150 may receive the control signal CTRL from the outside. The controller 150 may generate the gate control signal GCS, the data control signal DCS, and the voltage control signal VCS in response to the control signal CTRL. The controller 150 may receive the compensation image data CGD from the compensator 110. The controller 150 may convert the compensation image data CGD to be suitable for the display device DD or the display panel DP and output the image data DATA. In embodiments, the controller 150 may output the image data DATA by aligning the compensation image data CGD to fit the sub-pixels SP in rows.

Two or more components of the data driver 130, the voltage generator 140, and the controller 150 may be mounted in one integrated circuit. In an embodiment, the data driver 130, the voltage generator 140, and the controller 150 may be included in a driver integrated circuit (DIC). In such an embodiment, the data driver 130, the voltage generator 140, and the controller 150 may be functionally distinct components within one driver integrated circuit (DIC). In other embodiments, at least one of the data driver 130, the voltage generator 140, and the controller 150 may be provided as a component separate from the driver integrated circuit (DIC).

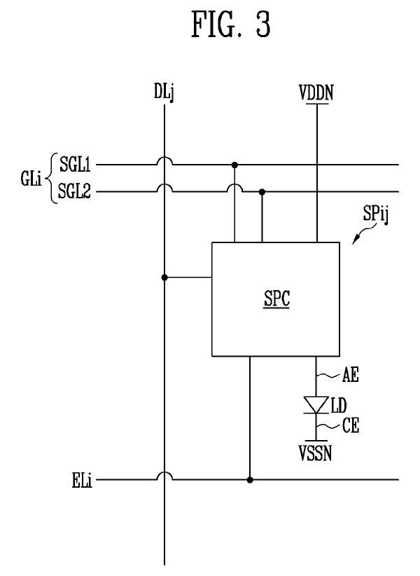

FIG. 3 is a block diagram illustrating an embodiment of one of the sub-pixels of FIG. 2.

In FIG. 3, among the sub-pixels SP of FIG. 2, a sub-pixel SPij arranged in an i-th row (i is an integer greater than or equal to 1 and less than or equal to m) and a j-th column (j is an integer greater than or equal to 1, and less than or equivalent to n) is shown as an example.

Referring to FIG. 3, an embodiment of the sub-pixel SPij may include a sub-pixel circuit SPC and a light emitting element LD.

The light emitting element LD may be connected between the first power supply voltage node VDDN and the second power supply voltage node VSSN. In this case, the first power voltage node VDDN may be a node that transmits the first power supply voltage VDD of FIG. 2, and the second power voltage node VSSN may be a nodes that transmit the second power supply voltage VSS of FIG. 2.

The anode electrode AE of the light emitting element LD may be connected to the first power supply voltage node VDDN through the sub-pixel circuit SPC, and the cathode electrode CE of the light emitting element LD may be coupled to the second power supply voltage node VRSN. In an embodiment, for example, the anode electrode AE of the light emitting element LD may be connected to the first power supply voltage node VDDN through one or more transistors included in the sub-pixel circuit SPC.

The sub-pixel circuit SPC may be connected to an i-th gate line GLi among the first to m-th gate lines GL1 to GLm of FIG. 2, an i-th light emission control line ELi among the first to n-th light emission control lines EL1 to ELm of FIG. 2, and a j-th data line DLj among the first to N-th data lines DL1 to DLn of FIG. 2. The sub-pixel circuit SPC may be configured to control the light emitting element LD based on signals received through these signal lines.

The sub-pixel circuit SPC may operate in response to a gate signal received through the i-th gate line GLi. The i-th gate line GLi may include one or more sub-gate lines. In embodiments, as shown in FIG. 3, the i-th gate line GLi may include first and second sub-gate lines SGL1 and SGL2. The sub-pixel circuit SPC may operate in response to gate signals received via the first and second sub-gate lines SGL1, SGL2. As such, when the i-th gate line GLi includes two or more sub-gate lines, the sub-pixel circuit SPC may operate in response to gate signals received through the corresponding sub-gate lines.

The sub-pixel circuit SPC may operate in response to a light emission control signal received through the i-th light emission control line ELI. In embodiments, the i-th emission control line ELI may include one or more sub-emission control lines. In an embodiment where the i-th light emission control line ELI includes two or more sub-light emission control lines, the sub-pixel circuit SPC may operate in response to light emission control signals received through the corresponding sub-light emission control line.

The sub-pixel circuit SPC may receive a data signal through the j-th data line DLj. The sub-pixel circuit SPC may store a voltage corresponding to the data signal in response to at least one of the gate signals received through the first and second sub-gate lines SGL1 and SGL2. In response to the light emission control signal received through the i-th light emission control line ELI, the sub-pixel circuit SPC may adjust a current flowing from the first power supply voltage node VDDN to the second power supply voltage node VSSN through the light emitting element LD according to the stored voltage. Accordingly, the light-emitting element LD may generate light having a luminance corresponding to the data signal.

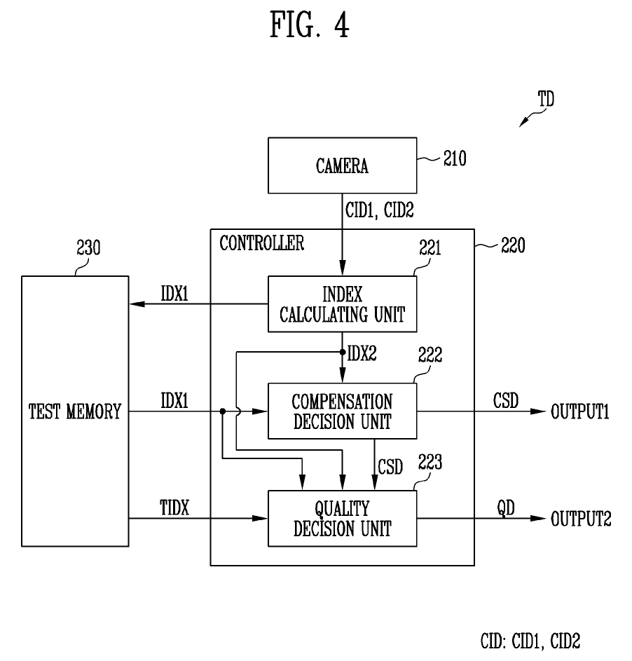

FIG. 4 is a block diagram illustrating an embodiment of the inspection device of FIG. 1.

Referring to FIG. 4, in an embodiment, the inspection device TD may include a camera 210, a controller 220, and a test memory 230. The controller 220 may include an index calculating unit 221, a compensation decision unit 222, and a quality decision unit 223.

The cameras 210 may be above the display panel DP to be spaced apart from the display panel DP. The camera 210 may obtain the images CID by capturing the display panel DP of the display device DD. In an embodiment, for example, when the display device DD receives the reference image data having the reference grayscale to display an image, the camera 210 may capture the display panel DP to obtain the corresponding first image CID1 before compensation. When the display device DD displays an image by receiving the compensation image data, to which the compensation grayscale is applied to the reference grayscale, the camera 210 may capture the display panel DP to obtain the corresponding second image CID2 after compensation.

The camera 210 may be a two-dimensional charge coupled device (CCD) camera, such as a region scan camera or a frame camera. Here, the first and second images CID1 and CID2 may include information about grayscale. The camera 210 may provide the first and second images CID1 and CID2 to the controller 220.

The controller 220 may receive images CID from the camera 210. In an embodiment, the controller 220 may be connected to the camera 210 via a communication cable. However, embodiments are not limited thereto. In another embodiment, for example, controller 220 may receive images CID from camera 210 via wireless communication. The controller 220 may include a processor and a communication interface for communicating with the camera 210.

The index calculating unit 221 may receive the images CID from the camera 210. The index calculating unit 221 may calculate an index for the image quality of the display panel DP from the images CID. The index calculating unit 221 may calculate the first index IDX1 for the image quality of the display panel DP, to which the compensation grayscale is not applied, from the grayscale of the first image CID1. In an embodiment, for example, the index calculating unit 221 may calculate the first index IDX1 by comparing the grayscale of the first image CID1 with the reference grayscale of reference image data provided to the display device DD. In an embodiment, for example, the first index IDX1 may be greater as the difference between the grayscale of the first image CID1 and the reference grayscale is less, and may be less as the difference is greater. The first index IDX1 calculated from the index calculating unit 221 may be stored in the test memory 230.

In addition, the index calculating unit 221 may calculate the second index IDX2 for the image quality of the display panel DP, to which the compensation grayscale is applied, from the grayscale of the second image CID2. In an embodiment, for example, the index calculating unit 221 may calculate the second index IDX2 by comparing the grayscale of the second image CID2 with the reference grayscale of the reference image data. In an embodiment, for example, the second index IDX2 may be greater as the difference between the grayscale of the second image CID2 and the reference grayscale is less, and may be less as the difference is greater. Although FIG. 4 illustrates an embodiment where the second index IDX2 calculated from the index calculating unit 221 is provided to the compensation decision unit 222, this is merely an example and embodiments are not limited thereto. In another embodiment, for example, the second index IDX2 may be stored in the test memory 230.

The compensation decision unit 222 may receive the first index IDX1 from the test memory 230 and receive the second index IDX2 from the index calculating unit 221. The compensation decision unit 222 may determine whether to apply a compensation grayscale to the display device DD (CSD). The compensation decision unit 222 may compare the first index IDX1 obtained from the first image CID1 with the second index IDX2 obtained from the second image CID2 to determine whether to apply a compensation grayscale to the display device DD (CSD). Information on whether to apply the compensation grayscale (CSD) may be included in the first output data OUTPUT1. The display device DD may be controlled to apply or not to apply the compensation grayscale according to the first output data OUTPUT1.

According to an embodiment, when the second index IDX2 is greater than the first index IDX1, the compensation decision unit 222 may determine to apply a compensation grayscale to the display device DD. When the second index IDX2 is less than or equal to the first index IDX1, the compensation decision unit 222 may determine not to apply the compensation grayscale to the display device DD.

The quality decision unit 223 may receive whether to apply the compensation grayscale (CSD) from the compensation decision unit 222. The quality decision unit 223 may receive the first index IDX1 from the test memory 230 or the second index IDX2 from the index calculating unit 221 according to whether to apply the compensation grayscale (CSD).

The quality decision unit 223 may determine whether the display device DD is a defective (or normal) based on one of the first index IDX1 and the second index IDX2. The determination result of the defect QD may be included in the second output data OUTPUT2.

In an embodiment, for example, when the compensation decision unit 222 determines to apply the compensation grayscale to the display device DD, the quality decision unit 223 may determine whether the display device DD is a defective (or normal) based on the second index IDX2 calculated from the second image CID2 after compensation. In an embodiment, for example, when the second index IDX2 is less than a predetermined target index TIDX, the quality decision unit 223 may determine that the display device DD is defective. When the second index IDX2 is greater than or equal to the predetermined target index TIDX, the quality decision unit 223 may determine that the display device DD is normal.

When the compensation decision unit 222 determines not to apply the compensation grayscale to the display device DD, the quality decision unit 223 may determine whether the display device DD is a defective (or normal) (or output determination result of the defect QD) based on the first index IDX1 calculated from the first image CID1 before compensation. In an embodiment, for example, when the first index IDX1 is less than the predetermined target index TIDX, the quality decision unit 223 may determine that the display device DD is defective. When the first index IDX1 is greater than or equal to the predetermined target index TIDX, the quality decision unit 223 may determine that the display device DD is normal.

The test memory 230 may store the first index IDX1 calculated from the index calculating unit 221 and the predetermined target index TDX. The test memory 230 may be configured as a memory separate from the controller 220, or may be configured as part of the controller 220.

FIG. 5 is a flowchart illustrating a method of controlling a display device according to an embodiment of the present disclosure.

Referring to FIGS. 1 and 5, a method of controlling a display device DD according to embodiments of the present disclosure may perform selective compensation by determining whether to apply a compensation grayscale to the display device DD (CSD).

In an embodiment, reference image data having a reference grayscale may be provided to the display device DD (S100). The display device DD may receive the reference image data and display an image corresponding to the reference grayscale. In an embodiment, for example, where the image data may represent grayscales from 0 to 255, the reference grayscale may be set to one of the grayscales within the range of 0 to 255.

In an embodiment, the inspection device TD may obtain a first image by capturing the display panel DP (S101). The inspection device TD may obtain a first image by capturing an image displayed on the display panel DP based on the reference image data.

In an embodiment, the inspection device TD may calculate a first index for the image quality of the first image (S102). The inspection device TD may obtain information about grayscales of the sub-pixels SP displayed in response to the reference grayscale from the first image. The inspection device TD may calculate the first index IDX1 (see FIG. 4) by comparing the reference grayscales of the reference image data with the grayscales of the first image. In an embodiment, for example, the inspection device TD may calculate the first index IDX1 based on the sum (or average) of the reference grayscales of the reference image data and the sum (or average) of the grayscales of the first image. In an embodiment, for example, the inspection device TD may calculate the first index IDX1 based on a difference between the sum (or average) of the reference grayscales of the reference image data and the sum (or average) of the grayscales of the first image. However, embodiments are not limited thereto.

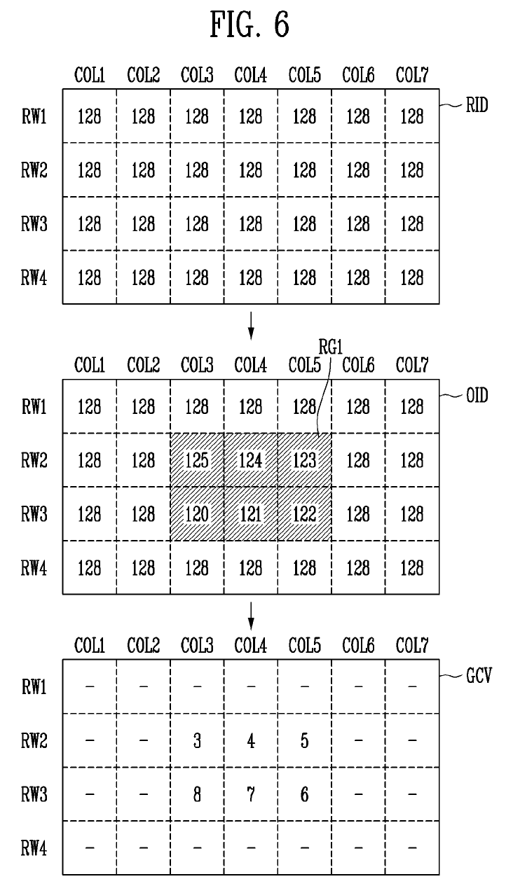

In an embodiment, compensation image data, with a compensation grayscale applied, may be provided to the display device DD (S103). The display device DD may receive the compensation image data and display an image in which the compensation grayscale is applied. The compensation image data may be generated by applying a compensation grayscale corresponding to the reference grayscale based on the reference image data. In an embodiment, for example, even if the reference grayscale of the reference image data is uniform, the grayscale of the image displayed on the display panel DP may not be uniform due to the characteristic deviation of the sub-pixels SP. Accordingly, the grayscale of the image displayed on the display panel DP may compensate for the characteristic deviation of the sub-pixels SP by applying the compensation grayscale to the reference grayscale. Details of the reference image data and the compensation image data will be described later with reference to FIG. 6.

In an embodiment, the inspection device TD may re-capture the display panel DP to obtain a second image (S104). The inspection device TD may capture an image displayed on the display panel DP based on the compensation image data to obtain a second image.

In an embodiment, the inspection device TD may calculate a second index (IDX2, see FIG. 4) for the image quality of the second image (S105). The inspection device TD may obtain information on grayscales of the sub-pixels SP displayed in response to the reference grayscale in which the compensation grayscale is applied from the second image. The inspection device TD may calculate the second index IDX2 by comparing the reference grayscales of the reference image data with the grayscales of the second image. In an embodiment, for example, the inspection device TD may calculate the second index (IDX2) based on the sum (or average) of the reference grayscales of the reference image data and the sum (or average) of the grayscales of the second image. In an embodiment, for example, the inspection device TD may calculate the second index (IDX2) based on a difference between the sum (or average) of the reference grayscales of the reference image data and the sum (or average) of the grayscales of the second image. However, embodiments are not limited thereto.

In an embodiment, the inspection device TD may determine whether the second index IDX2 is greater than the first index IDX1 (S106). The display device (DD) may have different characteristic deviations of the sub-pixels (SP) depending on the device, due to variations in the manufacturing process. In an embodiment, for example, the sample display device used as the reference of the compensation grayscale and a target display device DD being inspected may have different characteristic deviations of the sub-pixels SP. Accordingly, the shape of the stain displayed on the display panel DP of the target display device DD may be different from that of the display panel DP of the sample display device. If the shape of the stain is not the same, the compensation performance may be insufficient, or rather, the image quality after compensation may be degraded. Accordingly, the inspection device TD may determine whether to apply the compensation grayscale for each display device DD. In an embodiment, for example, the inspection device TD may determine whether to apply the compensation grayscale based on whether the second index IDX2 of the second image obtained after compensation is greater than the first index IDX1 of the first image obtained before compensation. Here, the first and second indices IDX1 and IDX2 are calculated in a same manner based on the grayscales of the first and second images, and it may be greater as the image quality of the display panel (DP) improves.

In an embodiment, when the second index IDX2 is greater than the first index IDX1 (YES in S106), the inspection device TD may determine to apply a compensation grayscale to the display device DD (S107). The inspection device TD may determine to apply the compensation grayscale to the display device DD when the second index IDX2 of the second image obtained after compensation is greater than the first index IDX1 of the first image obtained before compensation. In this case, the sub-pixels SP of the panel DP (shown in FIG. 2) may have more uniform grayscales after compensation than before compensation. Accordingly, the display device DD may improve the image quality of the display panel DP by applying the compensation grayscale.

In an embodiment, when the second index IDX2 is less than or equal to the first index IDX1 (NO in S106), the inspection device TD may determine not to apply the compensation grayscale to the display device (S108). The inspection device TD may determine not to apply the compensation grayscale to the display device DD when the second index IDX2 of the second image obtained after compensation is less than or equal to the first index IDX1 of the first image obtained before compensation. In this case, the sub-pixels SP of the panel DP may have more non-uniform grayscales after compensation than before compensation. Therefore, the display device DD may improve the image quality of the display panel DP by not applying the compensation grayscale.

In an embodiment, the inspection device TD may determine whether the final index is greater than the target index TIDX (see FIG. 4) (S109). The display device DD may or may not apply the compensation grayscale based on the determination of the inspection device TD. In an embodiment, for example, when the compensation grayscale is applied to the display device DD, the final index may be the second index IDX2 of the second image obtained after compensation. The inspection device TD may determine whether the second index IDX2 of the display device DD is greater than the predetermined target index TIDX. In addition, when the compensation grayscale is not applied to the display device DD, the final index may be the first index IDX1 of the first image obtained before compensation. The inspection device TD may determine whether the first index IDX1 of the display device DD is greater than the predetermined target index TIDX. Here, the predetermined target index TIDX is calculated based on the grayscales, and may serve as a criterion for determining whether the display device DD is normal or defective.

In an embodiment, when the final index is greater than or equal to the target index TIDX (YES in S109), the inspection device TD may determine that the display device DD is normal (S110). In an embodiment, for example, when the compensation grayscale is applied to the display device DD, when the second index IDX2 of the display device DD is greater than or equal to the predetermined target index TIDX, the inspection device TD may determine that the display device DD is normal. Further, when the compensation grayscale is not applied to the display device DD, when the first index IDX1 of the display device DD is greater than or equal to the predetermined target index TIDX, the inspection device TD may determine that the display device DD is normal.

In an embodiment, when the final index is less than the target index TIDX (NO in S109), the inspection device TD may determine that the display device DD is defective (S111). In an embodiment, for example, in a case where the compensation grayscale is applied to the display device DD, when the second index IDX2 of the display device DD is less than the predetermined target index TIDX, the inspection device TD may determine that the display device DD is defective. Further, in a case where the compensation grayscale is not applied to the display device DD, when the first index IDX1 of the display device DD is less than the predetermined target index TIDX, the inspection device TD may determine that the display device DD is defective.

FIG. 6 is a diagram illustrating an embodiment of compensation grayscale applied to the display device of FIG. 5.

Referring to FIGS. 2, 5, and 6 the display panel DP may include a plurality of sub-pixels SP. In the following description, for convenience of description, the display panel DP includes twenty eight sub-pixels SP arranged in four pixel rows RW1 to RW4 and seven pixel columns COL1 to COL7.

The reference image data RID having the reference grayscale may be input to the sample display device to obtain the compensation grayscale. The reference grayscale of the reference image data RID may be set to one of grayscales 0 to 255. However, the reference grayscale is not limited to this. Hereinafter, for convenience of description, a case where the reference grayscale is set to 128 grayscale will be mainly described.

According to an embodiment, when the reference image data RID having 128 grayscale is input to the sample display device, the sub-pixels SP in the display panel DP may display an image in response to the reference image data RID having 128 grayscale. The reference image OID may be obtained by capturing an image displayed in response to the reference image data RID on the display panel DP of the sample display device. Here, the reference image OID may include information on grayscales of the sub-pixels SP.

The reference image OID has 128 grayscale as a whole, but may have non-uniform grayscales other than 128 grayscale in some areas or regions. In an embodiment, for example, six sub-pixels corresponding to the first region RG1, among the sub-pixels SP in the display panel DP of the sample display device, may display grayscales less than 128. In an embodiment, for example, in the second pixel row RW2, sub-pixels arranged in the third pixel column COL3 may display 125 grayscales, sub-pixels placed in the fourth pixel column COL4 may display 124 grayscales, and sub-pixels disposed in the fifth pixel column COL5 may display 123 grayscales. In the third pixel row RW3, sub-pixels arranged in the third pixel column COL3 may display 120 grayscales, sub-pixels placed in the fourth pixel column COL4 may display 121 grayscales, and sub-pixels disposed in the fifth pixel column COL5 may display 122 grayscales. Among the sub-pixels SP, twenty two sub-pixels other than the first region RG1 may display 128 grayscales.

The compensation grayscale GCV may be calculated from the grayscale of the reference image OID based on the reference grayscale of reference image data RID. In an embodiment, for example, the compensation grayscale GCV may compensate grayscales of sub-pixels corresponding to the first region RG1 among the sub-pixels SP. In an embodiment, for example, in the second pixel row RW2, the compensation grayscale GCV may have three grayscale corresponding to the sub-pixels arranged in the third pixel column COL3, four grayscale corresponding the sub-pixel arranged in the fourth pixel column COL4, and five grayscale corresponding with the sub-pixel placed in the fifth pixel column COL5. The compensation grayscale GCV may have, in the third pixel row RW3, 8 grayscale corresponding to sub-pixels arranged in the third pixel column COL3, 7 grayscale corresponding the sub-pixels placed in the fourth pixel column COL4, and 6 grayscale corresponding a sub-pixel placed in the fifth pixel column COL5. The compensation grayscale GCV may have a zero grayscale corresponding to the remaining sub-pixels. However, this is described as an example, and the compensation grayscale GCV may be calculated using various known methods.

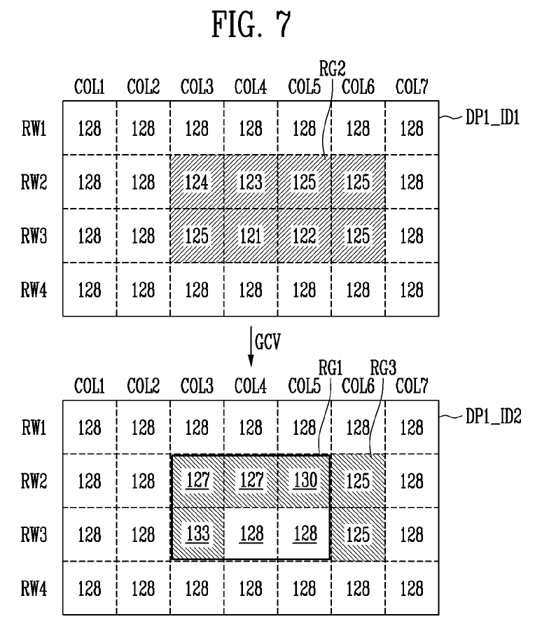

FIG. 7 is a diagram illustrating an embodiment in which a compensation grayscale is applied to the display device of FIG. 5.

Referring to FIGS. 5, 6, and 7 in an embodiment, when it is determined that the image quality of the display panel DP (see FIG. 1) is improved after compensation, the inspection device TD (see FIG. 1) may determine to apply the compensation grayscale CGV to the display device DD (see FIG. 2) (S107). In an embodiment, for example, when the second index (IDX2, see FIG. 4) is greater than the first index (IDX1, see FIG. 4), the inspection device TD may determine to apply the compensation grayscale CGV to the display device DD.

When the reference image data RID having the reference grayscale is provided to the display device DD, the display device DD may display the first image DP1_ID1 on the display panel DP in response to the reference image data RID. The first image DP1_ID1 has 128 grayscale as a whole, but may have non-uniform grayscales other than 128 grayscale in some areas or regions. The grayscale of the first image DP1_ID1 may not match the grayscale of the reference image OID.

In an embodiment, for example, eight sub-pixels corresponding to the second region RG2, among the sub-pixels SP in the display panel DP of the display device DD, may display grayscales less than 128. In an embodiment, for example, in the second pixel row RW2, sub-pixels arranged in the third pixel column COL3 may display 124 grayscales, and sub-pixels placed in the fourth pixel column COL4 may display 123 grayscales. In the second pixel row RW2, sub-pixels arranged in the fifth pixel column COL5 may display 125 grayscales, and sub-pixels placed in the sixth pixel column COL6 may display 125 grades. In the third pixel row RW3, sub-pixels disposed in the third pixel column COL3 may display 125 grayscales, and sub-pixels arranged in the fourth pixel column COL4 may display 121 grayscales. In the third pixel row RW3, sub-pixels arranged in the fifth pixel column COL5 may display 122 grayscales, and sub-pixels placed in the sixth pixel column COL6 may display 125 grayscales. Among the sub-pixels SP, the remaining twenty sub-pixels excluding the second region RG2 may display 128 grayscales.

When the compensation image data, to which the compensation grayscale CGV is applied to the reference grayscale, is provided to the display device DD, the display device DD may display the second image DP1_ID2 on the display panel DP in response to the compensation image data. Since the compensation grayscale CGV applied to the compensation image data is calculated based on the sample display device, it may be applied in the reference grayscale provided to the sub-pixels corresponding to the first region RG1. Accordingly, the display device DD may compensate for grayscales of sub-pixels corresponding to the first region RG1 among the sub-pixels SP in the display panel DP.

In an embodiment, for example, when the compensation grayscale CGV is applied to the display device DD, grayscales of six sub-pixels corresponding to the first region RG2 may be adjusted. In an embodiment, for example, the compensation grayscale CGV may compensate for grayscales of sub-pixels disposed in the third to fifth pixel rows COL3 to COL5 in the second and third pixel rows RW2 and RW3. When the compensation grayscale CGV is applied, in the second pixel row RW2, the sub-pixels arranged in the third pixel column COL3 may display 127 grayscale, the sub-pixel arranged in the fourth pixel column COL4 may display 127 greyscales, and the sub-pixel placed in the fifth pixel column COL5 may display 130 grayscales. In the third pixel row RW3, sub-pixels arranged in the third pixel column COL3 may display 133 grayscales, sub-pixels placed in the fourth pixel column COL4 may display 128 grayscales, and sub-pixels disposed in the fifth pixel column COL5 may display 128 grayscales.

In such an embodiment, the compensation grayscale CGV may not compensate for the grayscale of the sub-pixels disposed in the sixth pixel column COL6 of the second pixel row RW2 and the grayscale of sub-pixels arranged in the sixth pixel row COL6 of a third pixel row RW3. When the compensation grayscale CGV is applied, in the second pixel row RW2, the sub-pixels arranged in the sixth pixel column COL6 may display 125 grayscales. In the third pixel row RW3, sub-pixels arranged in the sixth pixel column COL6 may display 125 grayscales.

The first image DP1_ID1 obtained before compensation may have a non-uniform grayscales in eight sub-pixels corresponding to the second region RG2. The second image DP1_ID2 obtained after compensation may have a non-uniform grayscales in six sub-pixels corresponding to the third region RG3. In this case, the inspection device TD may determine that the second index IDX2 in the second image DP1_ID2 obtained after compensation is greater than the first index IDX1 in the first image DP1_ID1 obtained before compensation. That is, the inspection device TD may determine that the image quality of the display panel DP is improved after compensation. Accordingly, the inspection device TD may determine to apply the compensation grayscale CGV to the display device DD.

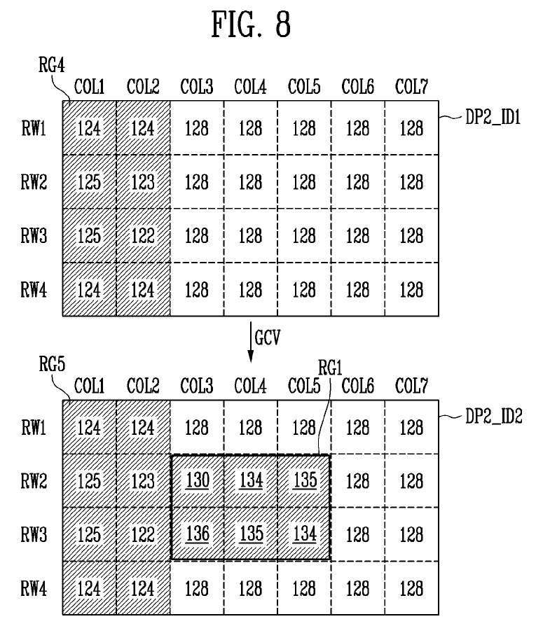

FIG. 8 is a diagram illustrating an embodiment in which a compensation grayscale is not applied to the display device of FIG. 5.

Referring to FIGS. 5, 6, and 8, in an embodiment, when it is determined that the image quality of the display panel DP (see FIG. 1) is degraded after compensation, the inspection device TD (see FIG. 1) may determine not to apply the compensation grayscale CGV to the display device DD (see FIG. 2) (S108). In an embodiment, for example, when the second index (IDX2, see FIG. 4) is less than or equal to the first index (IDX1, see FIG. 4), the inspection device TD may determine not to apply the compensation grayscale CGV to the display device DD.

When the reference image data RID having the reference grayscale is provided to the display device DD, the display device DD may display the first image DP2_ID1 on the display panel DP in response to the reference image data RID. The first image DP2_ID1 has 128 grayscale as a whole, but may have non-uniform grayscales other than 128 grayscale in some areas or regions. The grayscale of the first image DP2_ID1 may not match the grayscale of the reference image OID.

In an embodiment, for example, eight sub-pixels corresponding to the fourth region RG4, among the sub-pixels SP in the display panel DP of the display device DD, may display grayscales less than 128. In an embodiment, for example, in the first pixel row RW1, sub-pixels arranged in the first pixel column COL1 may display 124 grayscales, and sub-pixels placed in the second pixel column COL2 may display 124 grayscales. In the second pixel row RW2, sub-pixels disposed in the first pixel column COL1 may display 125 grayscales, and sub-pixels arranged in the second pixel column COL2 may display 123 grayscales. In the third pixel row RW3, sub-pixels disposed in the first pixel column COL1 may display 125 grayscales, and sub-pixels arranged in the second pixel column COL2 may display 122 grayscales. In the fourth pixel row RW4, sub-pixels disposed in the first pixel column COL1 may display 124 grayscales, and sub-pixels arranged in the second pixel column COL2 may display 124 grayscales. Among the sub-pixels SP, the remaining 20 sub-pixels excluding the fourth region RG4 may display 128 grayscales.

When the compensation image data, to which the compensation grayscale CGV is applied to the reference grayscale, is provided to the display device DD, the display device DD may display the second image DP2_ID2 on the display panel DP in response to the compensation image data. Since the compensation grayscale CGV applied to the compensation image data is calculated based on the sample display device, it may be applied in the reference grayscale provided to the sub-pixels corresponding to the first region RG1. Accordingly, the display device DD may compensate for grayscales of sub-pixels corresponding to the first region RG1 among the sub-pixels SP in the display panel DP.

In an embodiment, for example, when the compensation grayscale CGV is applied to the display device DD, grayscales of six sub-pixels corresponding to the first region RG2 may be adjusted. In an embodiment, for example, the compensation grayscale CGV may compensate for grayscales of sub-pixels disposed in the third to fifth pixel rows COL3 to COL5 in the second and third pixel rows RW2 and RW3. When the compensation grayscale CGV is applied, in the second pixel row RW2, sub-pixels arranged in the third pixel column COL3 may display 130 grayscales, sub-pixels placed in the fourth pixel column COL4 may display 134 grayscales, and sub-pixels disposed in the fifth pixel column COL5 may display 135 grayscales. In the third pixel row RW3, sub-pixels arranged in the third pixel column COL3 may display 136 grayscales, sub-pixels placed in the fourth pixel column COL4 may display 135 grayscales, and sub-pixels disposed in the fifth pixel column COL5 may display 134 grayscales. As such, the second image DP2_ID2 may have a non-uniform grayscales in the sub-pixels corresponding to the first region RG1 due to the application of the compensation grayscale CGV.

In such an embodiment, the compensation grayscale CGV may not compensate the grayscales of the eight sub-pixels corresponding to the fourth region RG2 of the first image DP2_ID1. The grayscales of the eight sub-pixels corresponding to the fourth region RG2 of the first image DP2_ID1 may be identically displayed in the second image DP2_ID2.

The first image DP2_ID1 obtained before compensation may have a non-uniform grayscales in eight sub-pixels corresponding to the fourth region RG4. The second image DP2_ID2 obtained after compensation may have a non-uniform grayscales in fourteen sub-pixels corresponding to the fifth region RG5. In this case, the inspection device TD may determine that the second index IDX2 in the second image DP2_ID2 obtained after compensation is less than the first index IDX1 in the first image DP2_ID1 obtained before compensation. That is, the inspection device TD may determine that the image quality of the display panel DP has degraded after compensation. Accordingly, the inspection device TD may determine not to apply the compensation grayscale CGV to the display device DD.

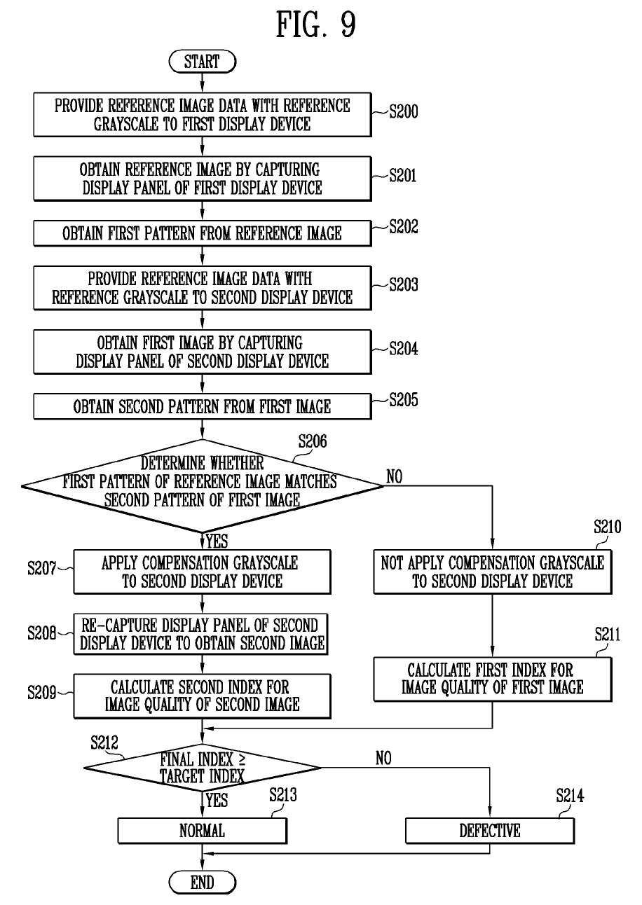

FIG. 9 is a flowchart illustrating a method of controlling a display device according to another embodiment of the present disclosure.

Referring to FIGS. 1 and 9, a method of controlling a display device DD according to other embodiments of the present disclosure may perform selective compensation by determining whether to apply a compensation grayscale to the display device DD (CSD). Hereinafter, in description of the embodiment of the method of controlling the display device DD shown in FIG. 9, any repetitive detailed descriptions of the same or like elements as those of FIG. 5 will be omitted or simplified.

In an embodiment, reference image data having a reference grayscale may be provided to the first display device (S200). The first display device may receive the reference image data and display an image corresponding to the reference grayscale. Here, the first display device may be a sample display device used as a reference for compensation grayscale.

In an embodiment, the inspection device TD may obtain a reference image by capturing a display panel of the first display device (S201). The inspection device TD may obtain a reference image by capturing an image displayed on the display panel of the first display device in response to the reference image data.

In an embodiment, the inspection device TD may obtain a first pattern from the reference image (S202). The inspection device TD may obtain the first pattern from the grayscale of the reference image displayed in response to the reference grayscale. Here, the first pattern may be in the form of a stain that appears because the grayscale of the reference image is non-uniform.

In an embodiment, reference image data having a reference grayscale may be provided to the second display device (S203). The second display device may receive the reference image data and display an image corresponding to the reference grayscale. Here, the second display device may be a display device to be inspected, and a compensation grayscale may or may not be applied. In addition, the reference image data provided to the second display device may have the same reference grayscale as the reference image data provided to the first display device.

In an embodiment, the inspection device TD may obtain a first image by capturing a display panel of the second display device (S204). The inspection device TD may obtain the first image by capturing an image displayed on the display panel of the second display device in response to the reference image data.

In an embodiment, the inspection device TD may obtain a second pattern from the first image (S205). The inspection device TD may obtain the second pattern from the grayscale of the first image that appears corresponding to the reference grayscale. Here, the second pattern may be in the form of a stain that appears because the grayscale of the first image may be non-uniform.

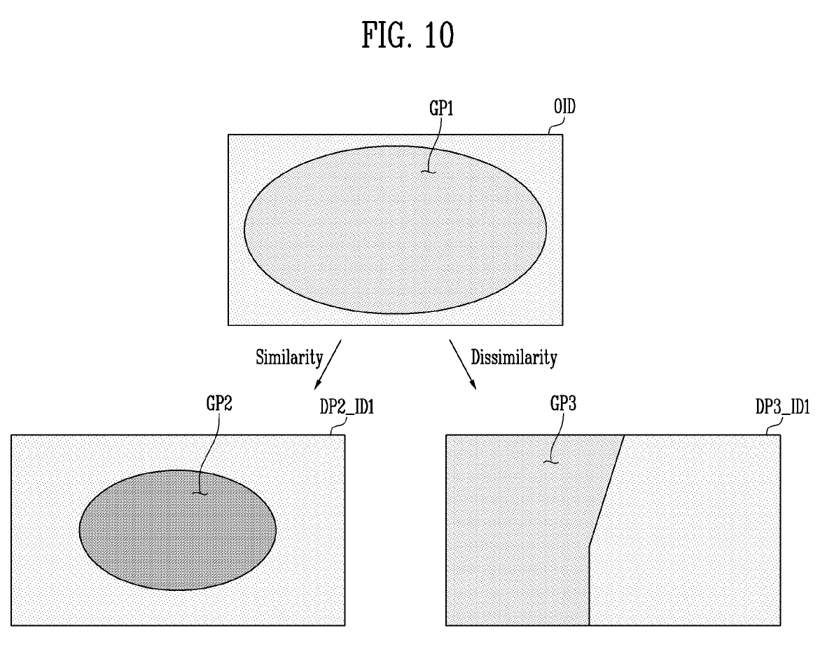

In an embodiment, the inspection device TD may determine whether the first pattern of the reference image matches the second pattern of the first image (S206). The compensation grayscale may be calculated based on the first pattern. When the second pattern of the first image has the same or similar grayscale as the first pattern of the reference image, the compensation grayscale may be suitable for compensating for the second pattern of first image. Accordingly, the display panel of the second display device may have improved image quality after compensation. On the other hand, if the second pattern of the first image has a grayscale that is different from or dissimilar to the first pattern of the reference image, the compensation grayscale may not be suitable for compensating for the second pattern of first image. Accordingly, the image quality of the display panel of the second display device may degrade after compensation. Accordingly, the inspection device TD may determine whether to apply the compensation grayscale based on whether the first pattern of the reference image matches the second pattern of the first image. Details of the first pattern of the reference image and the second pattern of the first image will be described later with reference to FIG. 10.

In an embodiment, the inspection device TD may determine that a compensation grayscale is desired be applied to the second display device when the first pattern of the reference image and the second pattern of the first image match each other (YES in S206). When determining that the compensation grayscale calculated based on the first pattern is also suitable for the second pattern of the first image, the inspection device TD may determine to apply the compensation grayscale to the second display device (S207).

In an embodiment, when it is determined to apply the compensation grayscale to the second display device, the inspection device TD may re-capture the display panel of the second display device to obtain a second image (S208). The inspection device TD may re-capture an image displayed on the display panel of the second display device in response to the compensation image data to obtain a second image.

In an embodiment, the inspection device TD may calculate a second index (IDX2, see FIG. 4) for the image quality of the second image (S209). The inspection device TD may obtain information about grayscales of sub-pixels in which the compensation grayscale is applied from the second image. The inspection device TD may calculate the second index IDX2 by comparing the reference grayscales of the reference image data with the grayscales of a second image.

In an embodiment, when the first pattern of the reference image and the second pattern of the first image do not match each other (NO in S206), the inspection device TD may determine not to apply the compensation grayscale to the second display device (S210). When it is determined that the compensation grayscale calculated based on the first pattern is not suitable for the second pattern of the first image, the inspection device TD may determine not to apply the compensation grayscale to the second display device.

In an embodiment, when it is determined not to apply the compensation grayscale to the second display device, the inspection device TD may calculate a first index (IDX1, refer to FIG. 4) for the image quality of the first image (S211). The inspection device TD may obtain information about grayscales of sub-pixels from the first image. The inspection device TD may calculate the first index IDX1 by comparing the reference grayscales of the reference image data with the grayscales of a first image.

In an embodiment, the inspection device TD may determine whether the final index is greater than the target index TIDX (see FIG. 4) (S212). According to the determination of the inspection device TD, it is possible to inspect whether the second display device is defective. The inspection device TD may compare the index for the image quality of the second display device with a predetermined target index TIDX to determine whether there is a defect.

In an embodiment, for example, when the compensation grayscale is applied to the second display device, the final index may be the second index IDX2 of the second image obtained after compensation. The inspection device TD may determine whether the second index IDX2 is greater than the predetermined target index TIDX. In addition, when the compensation grayscale is not applied to the second display device, the final index may be the first index IDX1 of the first image obtained before compensation. The inspection device TD may determine whether the first index IDX1 is greater than the predetermined target index TIDX. Here, the predetermined target index TIDX is calculated based on the grayscales, and may serve as a criterion for determining whether the display device DD is normal or defective.

In an embodiment, when the final index is greater than or equal to the target index TIDX (YES in S212), the inspection device TD may determine that the second display device is normal (S213). In an embodiment, for example, when the compensation grayscale is applied to the second display device, the inspection device TD may determine that the second display device is normal when the second index IDX2 is greater than or equal to the predetermined target index TIDX. Further, when the compensation grayscale is not applied to the second display device, when the first index IDX1 of the second display device is greater than or equal to the predetermined target index TIDX, the inspection device TD may determine that the second display device is normal.

In an embodiment, when the final index is less than the target index TIDX (NO in S212), the inspection device TD may determine that the second display device is defective (S214). In an embodiment, for example, when the compensation grayscale is applied to the second display device, the inspection device TD may determine that the second display device is defective when the second index IDX2 is less than the predetermined target index TIDX. In addition, when the compensation grayscale is not applied to the second display device, the inspection device TD may determine that the second display device is defective when the first index IDX1 is less than the predetermined target index TIDX.

FIG. 10 is a diagram illustrating an embodiment in which the first pattern and the second pattern of FIG. 9 are matched.

Referring to FIG. 10, in an embodiment, the controller 220 may determine whether the first pattern GP1 of the reference image OID obtained from the sample display device matches the second pattern of the first image obtained from the target display device before compensation. In an embodiment, although not shown in FIG. 4, the controller 220 may further include a pattern calculating unit. In such an embodiment, the compensation decision unit 222 of FIG. 4 may determine whether to match the patterns and determine whether to apply compensation to the display device DD.

In an embodiment, for example, in the first image DP2_ID1 obtained from the second display device, which is the object of inspection, may have a second pattern GP2 with grayscale similar to or the same as the first pattern GP1 of the reference image OID. In an embodiment, for example, the first pattern GP1 of the reference image OID may be an elliptical pattern, and the second pattern GP2 of the first image DP2_ID1 may be an ellipsoidal pattern that is different in size from the first pattern GP1, only. In this case, the controller 220 may determine that the first pattern GP1 of the reference image OID and the second pattern GP2 of the first image DP2_ID1 match each other. Accordingly, the second display device may be controlled to apply a compensation grayscale set based on the first pattern GP1 of the reference image OID. The display panel of the second display device may have improved image quality by applying a compensation grayscale.

In an embodiment, for example, in the first image DP3_ID1 obtained from the third display device, which is the object of inspection, may have a third pattern GP3 with a grayscale dissimilar to the first pattern GP1 of the reference image OID. In an embodiment, for example, the first pattern GP1 of the reference image OID may be an elliptical pattern, and the third pattern GP3 of the first image DP3_ID1 may be a square pattern. In this case, the controller 220 may determine that the first pattern GP1 of the reference image OID and the third pattern GP3 of the first image DP3_ID1 do not match each other. Accordingly, the third display device may be controlled not to apply the compensation grayscale set based on the first pattern GP1 of the reference image OID. The display panel of the third display device may have a lower image quality by applying a compensation grayscale.

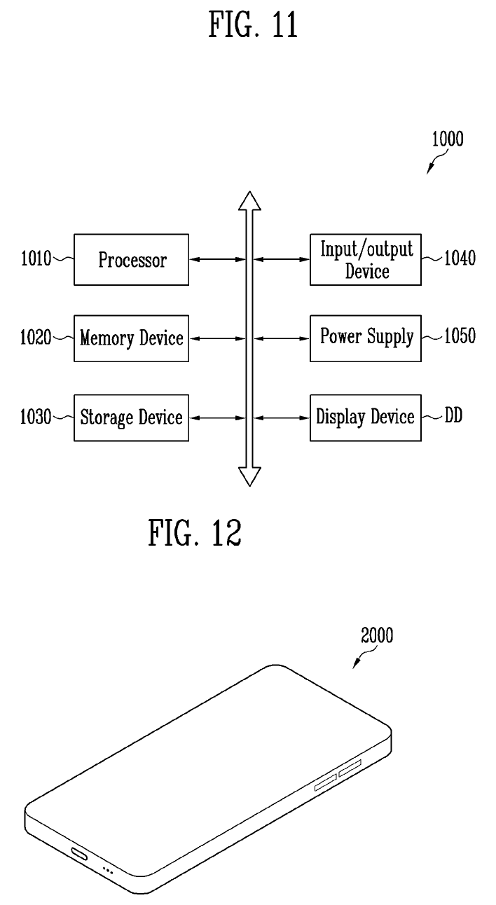

Hereinafter, an electronic device 1000 including the display device DD manufactured according to the method for controlling the display device DD described above will be described with reference to FIGS. 11 to 13.

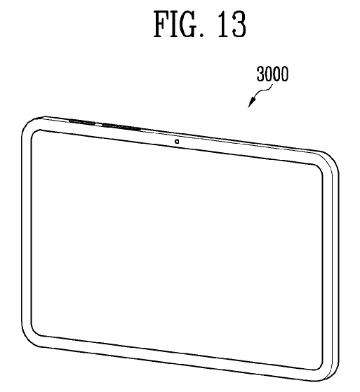

FIG. 11 is a block diagram illustrating an embodiment of an electronic device 1000 including the display device of FIG. 2. FIG. 12 is a diagram illustrating an example where the electronic device 1000 of FIG. 11 is a smartphone. FIG. 13 is a diagram illustrating an example where the electronic device 1000 of FIG. 10 is a tablet computer.

Referring to FIG. 11, an embodiment of the electronic device 1000 may include a processor 1010, a memory device 1020, a storage device 1030, an input/output device 1040, a power supply 1050, and a display device DD.

In embodiments, as shown in FIG. 12, the electronic device 1000 may be implemented as a smartphone 2000. In other embodiments, as shown in FIG. 13, the electronic device 1000 may be implemented as a tablet computer 3000. However, this is merely an example, and the electronic device 1000 is not limited thereto. In an embodiment, for example, the electronic device 1000 may be an electronic device (or a computing system) including the foregoing display device DD, such as a digital television, a three-dimensional (3D) television (TV), a personal computer (PC), a home electronic device, a laptop computer, a mobile phone, a video phone, a smart pad, a smart watch, a head mounted display device, a personal digital assistant (PDA), a portable multimedia player (PMP), a digital camera, a music player, a portable game console, navigation, or the like.

The processor 1010 may perform various tasks and calculations. In embodiments, the processor 1010 may include an application processor, a graphics processing unit, a microprocessor, a central processing unit (CPU), or the like. The processor 1010 may be connected to other components of the electronic device 1000 through a bus system. In embodiments, the bus system may include a peripheral component interconnect (PCI) bus. The processor 1010 may provide a data stream to be displayed on the display device DD to the display device DD.

The memory device 1020 may be provided as a working memory and/or a buffer memory of the electronic device 1000 and/or the processor 1010. In embodiments, memory device 1020 may include volatile memory devices such as dynamic random access memory (DRAM), static random access memory (SRAM), mobile DRAM, and the like.

The storage device 1030 may store data in response to control of the processor 1010. The storage device 1030 may include a nonvolatile storage medium that maintains data even when the power of the electronic device 1000 is cut off. In embodiments, storage device 1030 may include a solid state drive (SSD), a hard disk drive (HDD), or the like.

The input/output device 1040 may include user input devices such as a keyboard, keypad, touchpad, touchscreen, mouse, and the like, and output devices such as a speaker, printer, and the like.

The power supply 1050 may supply power used for the operation of the electronic device 1000. In an embodiment, for example, the power supply 1050 may be a power management integrated circuit (PMIC). In an embodiment, for example, the power supply 1050 may include a battery.

The display device DD may display an image in response to the control of the processor 1010. The display device DD may be connected to other components of the electronic device 1000 via a bus system and/or other communication link. The display device DD may be implemented as the display device DD of FIG. 2.

In the method of controlling a display device according to embodiments of the present disclosure, by providing reference image data having a reference grayscale and compensation image data, to which a compensation grayscale is applied to the reference grayscale, to the display device, respectively, and comparing the image quality index of the image before compensation with an image quality index of the image after compensation, it is possible to selectively determine whether to apply the compensation grayscale. Accordingly, even if the display device is normal, a problem in which the quality of the display device degrades after compensation may be improved, and the image quality and production yield of the display device may be improved.

According to embodiments of the present disclosure, a method for controlling a display device having improved display quality, an inspection device, and an electronic device are provided.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A method for controlling a display device, the method comprising:
providing reference image data having a reference grayscale to the display device to obtain a first image displayed by a display panel of the display device;
calculating a first index for image quality of the display panel from the first image;
providing compensation image data, to which a compensation grayscale is applied to the reference grayscale, to the display device to obtain a second image displayed on the display panel;
calculating a second index for image quality of the display panel from the second image; and
controlling the display device to apply the compensation grayscale when the second index is greater than the first index.

2. The method of claim 1, further comprising:
controlling the display device not to apply the compensation grayscale when the second index is less than or equal to the first index.

3. The method of claim 2, further comprising:
determining a defect of the display device based on one of the first index and the second index.

4. The method of claim 3, wherein
the determining the defect of the display device includes:
determining that the display device is defective when the compensation grayscale is applied to the display device and the second index is less than a predetermined target index.

5. The method of claim 3, wherein
the determining the defect of the display device includes:
determining that the display device is defective when the compensation grayscale is not applied to the display device and the first index is less than a predetermined target index.

6. The method of claim 1, wherein
the first index is calculated based on the reference grayscale and a grayscale of the first image displayed on the display panel with the reference image data, and
the second index is calculated based on the reference grayscale and a grayscale of the second image displayed on the display panel with the compensation image data.

7. A method for controlling a display device, the method comprising:
providing reference image data having a reference grayscale to a first display device to obtain a reference image displayed on a display panel of the first display device;
obtaining a first pattern based on the grayscale of the reference image;
providing the reference image data to a second display device to obtain a first image displayed on a display panel of the second display device;
obtaining a second pattern based on the grayscale of the first image; and
controlling the second display device to apply a compensation grayscale, which compensates for the reference grayscale of the first display device, thereto when the first pattern and the second pattern match each other.

8. The method of claim 7, further comprising:
controlling the second display device not to apply the compensation grayscale, thereto when the first pattern and the second pattern do not match each other.

9. The method of claim 8, further comprising:
when the compensation grayscale is not applied to the second display device,
calculating a first index for image quality of a display panel of the second display device from the first image; and
determining a defect of the second display device based on the first index.

10. The method of claim 9, wherein
the determining the defect of the second display device includes:
determining that the second display device is defective when the first index is less than a predetermined target index.

11. The method of claim 7, further comprising:
when the compensation grayscale is applied to the second display device,
providing compensation image data, to which the compensation grayscale is applied to the second display device, to obtain a second image displayed on the display panel of the second display device; and
calculating a second index for image quality of the display panel from the second image.

12. The method of claim 11, further comprising:
determining a defect of the second display device based on the second index.

13. The method of claim 12, wherein:
the determining the defect of the second display device includes:
determining that the second display device is defective when the second index is less than a predetermined target index.

14. An inspection device for inspecting a display device, the inspection device comprising:
a controller; and
a camera which obtains, in response to a control of the controller, a first image displayed on a display panel of the display device based on reference image data having a reference grayscale, and a second image displayed on the display panel based on compensation image data, to which a compensation grayscale is applied to compensate for the reference grayscale;
wherein the controller calculates a first index for image quality of the display panel from the first image, and a second index for image quality from the second image, controls the display device to apply the compensation grayscale when the second index is greater than the first index, and determines a defect of the display device based on one of the first index and the second index.

15. The inspection device of claim 14, wherein
the controller controls the display device not to apply the compensation grayscale when the second index is less than or equal to the first index.

16. The inspection device of claim 15, wherein
the controller determines that the display device is defective when the compensation grayscale is not applied to the display device and the first index is less than a predetermined target index.

17. The inspection device of claim 14, wherein
the controller determines that the display device is defective when the compensation grayscale is applied to the display device and the second index is less than a predetermined target index.
